(19) United States
(12) Patent Application Publication
(10) Pub. No.: US 2011/0226088 A1
(43) Pub. Date: Sep. 22, 2011

(54) STEERING WHEEL FOR A MOTOR VEHICLE

(76) Inventors: Norbert Müller, Aschaffenburg (DE); Bernhard Kempf, Kleinwallstadt (DE); Andreas Hans, Niedernberg (DE); Martin Sauer, Hosbach (DE); Achim Hartlaub, Grosswallstadt (DE); Claus Rudolf, Haibach (DE); Sebastian Dienert, Frankfurt (DE); Stephanie Broos, Aschaffenburg (DE)

(21) Appl. No.: 13/131,304

(22) PCT Filed: Nov. 26, 2009
(86) PCT No.: PCT/EP09/65934

§ 371 Date: May 26, 2011

(30) Foreign Application Priority Data
Nov. 28, 2008 (DE) 10 2008 060 184.5

(51) Int. Cl. B62D 1/08

(52) U.S. Cl. 74/552

(57) ABSTRACT

A steering wheel for a motor vehicle is provided. The steering wheel comprises a steering wheel rim, a hub body via which the steering wheel can be mounted rotarily around a steering axle on a motor vehicle and at least one spoke via which the hub body is connected to the steering wheel rim. The at least one spoke is designed to be adjustable with respect to the steering wheel rim.

The invention relates to a steering wheel for a motor vehicle.

Such a steering wheel usually has a steering wheel rim which can circulate along a circumferential direction in a closed circle, wherein the steering wheel can be actuated via said steering wheel rim to produce a change in direction of an allocated motor vehicle, a hub body, via which the steering wheel can be mounted rotarily around a steering axle on a motor vehicle, as well as at least one spoke, via which the hub body is connected to the steering wheel rim.

The problem underlying the invention is to develop a steering wheel which can be applied as versatile as possible.

This problem is solved by a steering wheel with the features of claim 1.

According to this it is provided that the at least one spoke is designed to be adjustable with respect to the steering wheel rim—with the steering wheel or steering wheel rim held steady. Or, to put it differently, at least one spoke is designed to be adjustable relative to the steering wheel rim or the hub body.

In one variant of the invention the at least one spoke is designed to be pivotable around the steering axle (or any other axle) with respect to the steering wheel rim. Here therefore, by pivoting the spoke, the position of the spoke is changed with respect to the steering wheel rim. To be able to pivot the at least one spoke in such a way it is best mounted pivotably on the hub body.

Furthermore, in one variant of the invention the at least one spoke is designed to be adjustable along a direction of extension (e.g. a radial direction with respect to the steering wheel), along which said direction the spoke extends, such that the length of the spoke is variable along the direction of extension. The spoke can here be designed as a telescopic spoke. That is, the spoke has at the least two elements which can slide onto each other or along each other, such that the two elements combined constitute a body of variable overall length.

Preferably, on a free end the spoke has a sleeve-shaped element which can in particular encompass the steering wheel rim in cross section, wherein said sleeve-shaped element is in particular installed and provided to slide along the steering wheel rim upon pivoting the at least one spoke. This can be accompanied by a changing of the shape of the steering wheel rim, for example in that said sleeve-shaped element pushes a segment of the steering wheel rim (or several segments) into a new, changed position in regard to the remaining segments of the steering wheel rim (this can be a forced movement).

Preferably therefore, the shape of the steering wheel rim can be changed by adjusting the spoke. The term shape in this case particularly means the contour of the steering wheel rim which runs along the circumferential direction. In this way, in sections the steering wheel rim can for instance run in the shape of a segment of a circle. This circular form can be flattened for instance by adjusting the at least one spoke (or several spokes).

Additionally, in one variant of the invention the circumference of the steering wheel rim is designed to be changeable by adjusting the spoke. In this way, for example by shortening the at least one spoke (or several existing spokes) along its direction of extension, the circumference of the steering wheel rim can be reduced by reducing the radius of the steering wheel rim. Reducing the radius is in this case accomplished by a shortening of the at least one spoke.

In one variant of the invention the steering wheel rim is made of a plurality of segments movably connected to each other, which facilitates changing the shape and/or the circumference of the steering wheel rim. In this way, the segments can for instance be articulated with each other and/or slide onto each other or be fastened together shiftably such that the steering wheel rim can be pushed/moved into a new, desired shape for instance by an adjustment of the at least one spoke as specified above.

Further advantages and features of the invention shall be made clear on the basis of the subsequent figure specifications of exemplary embodiments. In the Figures:

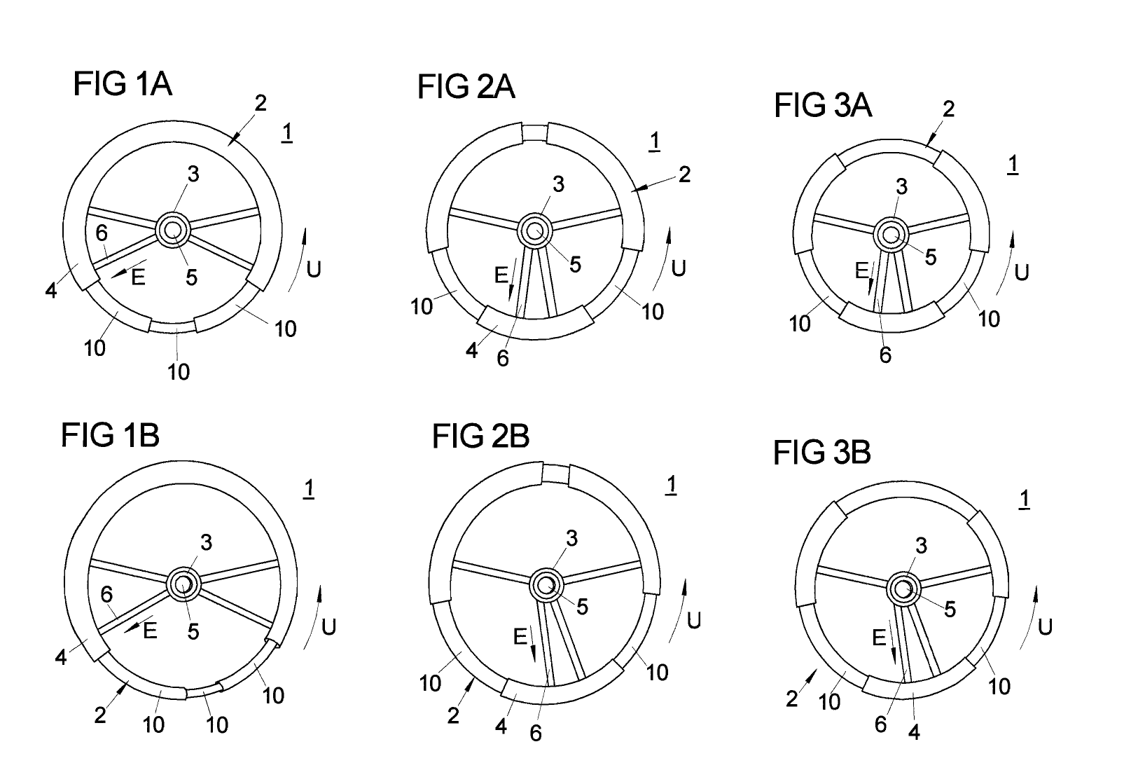

FIG. 1A shows a schematic top view of a steering wheel according to the invention with four adjustable spokes;

FIG. 1B shows the steering wheel according to FIG. 1A in a schematic, perspective view;

FIG. 2A shows a schematic top view of the steering wheel shown in FIGS. 1A and 1B, wherein the spokes were each pivoted downward with respect to the vertical vehicle axle;

FIG. 2B shows the steering wheel according to FIG. 2A in a schematic, perspective view;

FIG. 3A shows a schematic top view of the steering wheel according to FIGS. 1A to 2B, in which the spokes are shortened by adjustment to reduce the diameter of the steering wheel rim of the steering wheel;

FIG. 3B shows the steering wheel according to FIG. 3A in a schematic, perspective view;

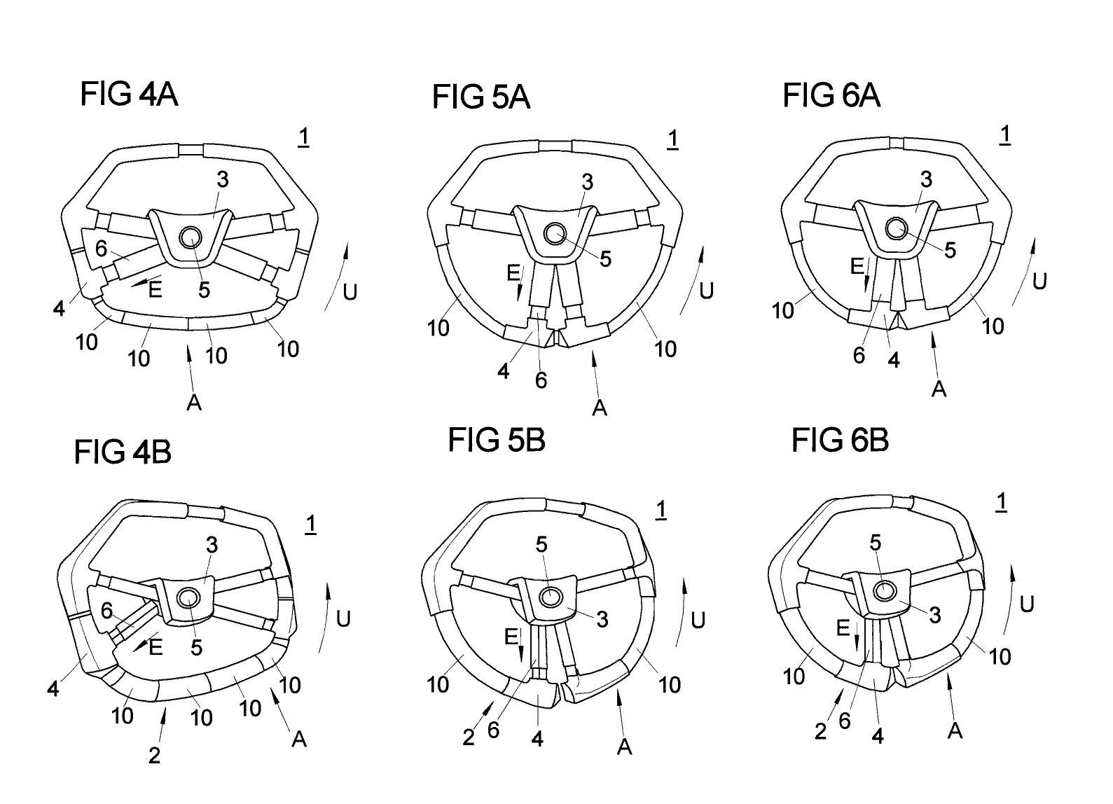

FIG. 4A shows a schematic top view of a further steering wheel according to the invention, with four adjustable spokes;

FIG. 4B shows the steering wheel shown in FIG. 4A in a schematic, perspective view;

FIG. 5A shows a schematic top view of the steering wheel shown in FIGS. 1A and 1B, wherein the two lower spokes were each pivoted downward with respect to the vertical vehicle axle, whereby the lower flattened steering wheel rim gets a curvature.

FIG. 5B shows the steering wheel according to FIG. 5A in a schematic, perspective view;

FIG. 6A shows a schematic top view of the steering wheel according to FIGS. 4A to 5B, in which the spokes are shortened by adjustment to reduce the diameter of the steering wheel rim of the steering wheel; and

FIG. 6B shows the steering wheel according to FIG. 6A in a schematic, perspective view.

FIG. 1A shows in connection with FIGS. 1B to 3B a steering wheel 1 for a motor vehicle, having a hub body 3 via which the steering wheel 1 can be mounted rotarily around a steering axle 5 on a motor vehicle. The steering wheel 1 has a steering wheel rim 2 circulating in a circumferential direction U which in particular circulates perpendicularly to the steering axle 5 along a circumferential direction U. Here the steering wheel rim 2 is in particular designed circular.

The steering wheel 1 moreover has four spokes 6, via which the hub body 3 is connected to the steering wheel rim 2. The spokes 6 here each branch off from the hub body 3 and each lead into the steering wheel rim 2, respectively. The spokes 6 are each one designed to extend longitudinally along a direction of extension E. The spokes 6 are designated clockwise as first, second, third and fourth spoke 6. Of course, there can also be provided more than four spokes 6 or less than four spokes 6.

The spokes 6 are each mounted pivotably on the hub body 3, in particular around the steering axle 5, such that they are adjustable with respect to the steering wheel rim 2 (assumed to be stationary). For this purpose the spokes 6 are each designed in such a way on the area 4 leading into the steering wheel rim 2 or on the area 4 connected to the steering wheel rim 2, that they can be moved or pivoted along the steering wheel rim 2. The spokes 6 can here encompass the steering wheel rim 2 in cross section, at the least in sections, for instance in that the individual spokes 6 each lead to a sleeve-shaped element 4 which said element 4 each encompasses a portion of the steering wheel rim 2 or represents a part of the steering wheel rim 2 which is movable in the circumferential direction U. Such an element 4 does, of course, not have to circulate in a closed circle but instead it can also be designed in the shape of an open ring in cross section.

As a consequence of this adjustability of the spokes 6 the positions of the spokes can be adapted to the individual requirements of a driver (the position of the spokes 6 will each be indicated below analogous to the position of a clock hand).

In FIG. 1A the four spokes 6, which in particular each run linear longitudinally extended, are each located close to the horizontal (with a steering wheel 1 in straightforward driving position), wherein the first spoke 6 has a slight inclination in regard to the horizontal and is located approximately in the 2:30 o'clock position. The second spoke 6 has a more pronounced inclination towards the horizontal and is positioned approximately in the 4:00 o'clock position. The third and fourth spoke 6 have a mirror-symmetrical layout to this, i.e. the third spoke 6 is positioned in the 8:00 o'clock position, the fourth spoke 6 approximately in the 9:30 o'clock position. The spokes 6 each lead to a sleeve-shaped element 4, which can each be shifted in the circumferential direction U along the steering wheel rim 2 as can be seen in FIG. 2A or 2B. These Figures specifically show the steering wheel 1 according to FIGS. 1A and 1B with pivoted spokes 6. Here the first and second spoke 6 were pivoted clockwise, whereas the third and fourth spoke 6 were pivoted counter-clockwise, such that now the first and fourth spoke 6 run close to the horizontal and the second and third spoke 6 run roughly parallel to each other and are each located close to the 6 o'clock position.

The pivoting can, where applicable, be undertaken by the driver or it can be accomplished by motor at the inducement of the driver. Of course, the pivoting of the spokes 6 can also be factory-made, wherein the spokes 6 can be fixed such that they can no longer be adjusted manually by the user (driver).

Additionally, there is the possibility that the spokes 6 according to FIGS. 3A and 3B can be shortened or lengthened along their respective direction of extension E to reduce or to enlarge the diameter (or, where applicable, the contour) of the steering wheel rim. For this purpose the steering wheel rim 2 is made of segments 10 which can be shifted into each other or which can be drawn apart to reduce or to enlarge the diameter or circumference of the steering wheel rim along the circumferential direction U.

The shifting of such segments 10 against each other can be illustrated as a forced movement which is initiated by the pivoting of the spokes 6.

In this case, by adjusting the spokes 6 (pivoting and/or shortening or lengthening) the contour of the steering wheel rim 2, that is to say its form, can also be changed.

In this way, FIG. 4A shows in connection with FIGS. 4B to 6B a steering wheel 1 with four spokes 6, which, corresponding with FIG. 1A, are designated as first, second, third and fourth spoke 6. In this case the position of the spoke according to FIG. 3A corresponds with the position of the spoke according to FIG. 1A. As in the first exemplary embodiment the spokes 4 are mounted pivotably on the hub body 3, wherein, however, the first and fourth spoke 6 in particular can be rigidly secured on the steering wheel rim 2.

As shown in FIG. 5A or 5B, in this exemplary embodiment the second and third spoke 6 in particular can be pivoted from the positions shown in FIGS. 4A and 4B in the direction of the 6:00 o'clock position (towards each other), wherein the sleeve-shaped elements 4 of said spokes 6 re-shape a (referring to the vertical vehicle axle) lower portion A of a steering wheel rim 2, positioned in straightforward driving position, which said lower portion A in the initial position of the second and third spoke 6 according to FIGS. 4A and 4B runs essentially extended longitudinally along the horizontal, into a portion A with a round curvature. This is due to the fact that the steering wheel rim 2 consists of segments 10 or has segments 10, which can be twisted against each other, i.e. in cross-sectional planes of the steering wheel rim 2, which are each extended perpendicularly to the circumferential direction U, wherein the individual segments 10, where applicable, also can be shifted into each other or can be drawn apart. These movements of the individual segments 10 of the steering wheel rim 2, which cause for instance a transformation of the steering wheel rim 2 from the roughly rectangular or hexagonal contour according to FIG. 1A into the semi-circular contour according to FIG. 5A, are forced movements which are predetermined by the shape of the sleeve-shaped elements 4 as well as the respective pivot angle of the second or third spoke 6.

Finally, in the second exemplary embodiment also the spokes 6 can be shortened to reduce the circumference of the steering wheel rim 2 altogether, wherein here in particular the two elements 4, to which the first or fourth spoke 6 lead, are brought closer to each other along the horizontal or along the directions of extension E of those said spokes 6 which are (roughly) adjusted parallel. Here the segments 10 of the aforementioned lower portion A of the steering wheel rim 2 can slide in sections, where applicable, into the lower sleeve-shaped elements 4 of the second and third spoke 6. Alternatively or supplementary those said segments 10 can also slide into the upper elements 4, to which the first and fourth spoke 6 lead, such that the circumference of the steering wheel rim 2 can be reduced altogether.

1. A steering wheel for a motor vehicle, having
a steering wheel rim,
a hub body, via which the steering wheel can be mounted rotarily around a steering axle on a motor vehicle,
at least one spoke, via which the hub body is connected to the steering wheel rim,
wherein the at least one spoke is designed to be adjustable with respect to the steering wheel rim.

2. The steering wheel according to claim 1, wherein the at least one spoke can be pivoted around the steering axle with respect to the steering wheel rim, wherein the at least one spoke is in particular mounted pivotably on the hub body.

3. The steering wheel according to claim 1, wherein the at least one spoke is designed to be adjustable along a direction of extension, along which the spoke extends, such that the length of the spoke is variable along the direction of extension.

4. The steering wheel according to claim 1, wherein the at least one spoke is designed as telescopic spoke.

5. The steering wheel according to claim 1, wherein the spoke leads to a sleeve-shaped element.

6. The steering wheel according to claim 5, wherein said sleeve-shaped element encompasses the steering wheel rim.

7. The steering wheel according to claim 5, wherein the sleeve-shaped element is designed to slide along the steering wheel rim upon pivoting the at least on spoke.

8. The steering wheel according to claim 1, wherein the shape of the steering wheel rim can be changed by adjusting the at least one spoke.

9. The steering wheel according to claim 1, wherein the circumference of the steering wheel rim can be changed by adjusting the at least one spoke.

10. The steering wheel according to claim 1, wherein the steering wheel rim has a plurality of segments movably connected to each other.

11. The steering wheel according to claim 1, comprising a plurality of adjustable spokes.
